(19) United States
(12) Patent Application Publication
(10) Pub. No.: US 2007/0128000 A1
(43) Pub. Date: Jun. 7, 2007

(54) Dispersed cholesteric liquid crystal display with color filter

(76) Inventors: Chao-Heng Huang, Sanchung City (TW); Jhih-Ping Lu, Sanchung City (TW)

Correspondence Address: PRO-TECHTOR INTERNATIONAL SERVICES, 20775 NORADA CT., SARATOGA, CA, 95070, US

(21) Appl. No.: 11/292,966

(22) Filed: Dec. 1, 2005

(51) Int. Cl. F16B 39/24

(52) U.S. Cl. 411/161

(57) ABSTRACT

A dispersed cholesteric liquid crystal display, comprises an upper substrate, an upper layer, a lower layer, divided by a plurality of barriers in a plurality of lower pieces placed in cells below which a plurality of absorption pieces are laid, a lower substrate, upper electrodes placed between the upper substrate and the upper layer, lower electrodes placed between the lower substrate and the lower layer, and cholesteric liquid crystal (CLC) material placed on the plurality of lower pieces, wherein the CLC material has red, green and blue color characteristics, so that red, green and blue pixels are formed. CLC material is applied on the lower pieces by spraying at increased temperature and consequently lower viscosity.

### BACKGROUND OF THE INVENTION

1. Field of the Invention

The present invention relates to a liquid crystal display, particularly to a dispersed cholesteric liquid crystal display or color filter of high quality and its manufacturing method.

2. Description of Related Art

Cholesteric liquid crystal displays work by bistable liquid crystal molecules, being able to hold image information without supply of power. Only change of images requires applying electrical voltage. Therefore, cholesteric liquid crystal displays are suited well for static applications, like advertisements or price information boards, as well as for portable applications, including foldable screens, like e-papers.

Among liquid crystal displays, cholesteric liquid crystal displays (CLCD) have particularly low power consumption, which is less than for STN or TN displays. Table 1 shows, for a 6.3 inch VGA full-color display and a 5.4 watt-hour battery, clearly different discharging and charging times. With a display time of 5 minutes per page, battery operating time reaches 1350 hours. With active matrix and 50% pixel refresh, 3200 hours of operating time is reached, which is significantly higher than for complete reloading of images. Thus application to dynamic images is not possible, but static images, e.g. for e-books, are well supported, with CLCDs achieving longer operating times than STNs with active matrix technology.

TABLE 1
Battery operating time for 6.3 inch VGA full-color
display

| | Reading speed, operating time until | | | |
|---|---|---|---|---|
| | recharge | | | |
| | | | | Min. |
| Display technique | 1 min. | 2 min. | 5 min. | per page |
| with backlighting | 2 hours | 2 hours | 2 hours | |
| source | | | | |
| immediate | | | | |
| refreshing of | | | | |
| image(like active | | | | |
| matrix STN or STN) | | | | |
| Reflective with | 18 hours | 18 hours | 18 hours | |
| economic electrode | | | | |
| Reflective | 270 hours | 540 hours | 1350 hours | |
| bistable CLCD | | | | |
| passive matrix | | | | |
| Reflective | 640 hours | 1280 hours | 3200 hours | |
| bistable CLCD | | | | |
| active matrix and | | | | |
| 50% pixel refresh | | | | |

CLCDs thus offer several advantages for displaying static images. However, conventional CLDCs are mostly monochrome and do not exhibit color displaying properties that are as good as those of active matrix displays and are therefore rarely found on the market.

For Bragg reflection, wavelength difference Δλ, helical order p and birefringence difference Δλ are governed by the relation Δλ=pΔn. The birefringence difference Δn in regular liquid crystal displays is about 0.1-0.2. Therefore, monochrome CLCDs for red, green or blue have already been developed. CLCDs offering full-color display, however, have been too complicated and expensive and thereby unsuitable for low-cost. applications.

Conventional color filters are not only expensive to manufacture, but have also the disadvantage of transparencies of only about 28%, with further losses in upper and lower polarizers reaching up to 50%, resulting in a total transparency of 7% of conventional LCDs. In contrast thereto, CLCDs generate polarized light, resulting in a total transparency of 26.8%, which is significantly higher.

U.S. Pat. No. 6,377, 321 “Stacked color liquid crystal display device” discloses red, green, blue aligned layers for displaying colors. However, for limiting parallactic effect and ensuring a good resolution, layers have to be thinner than 0.3 mm. Furthermore, overlapping pixels lead to longer manufacturing time and higher manufacturing cost. U.S. Pat. No. 6,061,107 “Bistable polymer dispersed cholesteric liquid crystal displays” teaches controlling of the helical order of molecules by transmitted ultraviolet light for attaining display of red, green and blue. This method cannot be performed in a single light screen. Finally, U.S. Pat. No. 5,949,513 “Methods of manufacturing multi-color liquid crystal displays using in situ mixing techniques” discloses mixing of molecules of various chirality, thus obtaining varying helical orders, to achieve displaying of different colors. However, thereby barriers between regions of different colors are required. Taiwan patent publication 578,925 discloses using liquid crystal material of a high birefringence difference as color filters for displaying various colors in CLCDs. However, conventional color filters are expensive to manufacture, and liquid crystal material of a high birefringence difference is hard to obtain and costlier than liquid crystal material for a single frequency.

There is, therefore, a demand for CLCDs that are cheap and easy to manufacture, yet offer full-color display.

### SUMMARY OF THE INVENTION

An object of the present invention is to provide a dispersed cholesteric liquid crystaldisplay or color filter which is able to display red, green and blue with high luminosity and low power consumption, is applicable to glass or plastics substrates of all sizes and easy and inexpensive to manufacture and a manufacturing method therefor.

The dispersed cholesteric liquid crystal display of the present invention comprises an upper substrate, an upper layer, a lower layer, divided by a plurality of barriers in a plurality of lower pieces placed in cells below which a plurality of absorption pieces are laid, a lower substrate, upper electrodes placed between the upper substrate and the upper layer, lower electrodes placed between the lower substrate and the lower layer, and cholesteric liquid crystal (CLC) material placed on the plurality of lower pieces, wherein the CLC material has red, green and blue color characteristics, so that red, green and blue pixels are formed. CLC material is applied on the lower pieces by spraying at increased temperature and consequently lower viscosity.

The dispersed cholesteric liquid crystal color filter of the present invention comprises an upper substrate, an upper layer, a lower layer, divided by a plurality of barriers in a plurality of lower pieces placed in cells below which a plurality of absorption pieces are laid, a lower substrate, and cholesteric liquid crystal (CLC) material placed on the plurality of lower pieces, wherein the CLC material has red, green and blue color characteristics, so that red, green and blue pixels are formed. CLC material is applied on the lower pieces by spraying at increased temperature and consequently lower viscosity.

The present invention offers the following two advantages: By using a spraying method, quick and inexpensive production is possible without employing expensive processes like semiconductor manufacturing processes with photo-resist techniques. By using software control, any desired spraying pattern is achievable and no limits as to shapes and sizes are given. By taking advantage of Bragg reflection and a high birefringence difference of CLC material, high luminosity and full-color display are attained without the use of polarizers, with displayed colors ranging from infrated to ultraviolet.

The present invention can be more fully understood by reference to the following description and accompanying drawings.

### DETAILED DESCRIPTION OF THE PREFERRED EMBODIMENTS

The present invention employs dispersion for applying cholesteric liquid crystals of three colors, red, green, blue, on glass and plastics substrates, combining dispersion technique with CLCD technology to generate full-color display using highly effective color filters.

As shown in FIG. 1, the present invention comprises: a plurality of barriers 2; a lower substrate 3, made of glass or plastics; cholesteric liquid crystal (CLC) material 4; a plurality of lower pieces 5; a plurality of absorption pieces 6; a plurality of upper electrodes 7; a higher layer 8; a higher substrate 9, made of glass or plastics; and a plurality of lower electrodes 10. The upper electrodes 7 are placed between the higher layer 8 and the higher substrate 9. Each of the barriers 2 rests on the lower substrate 3 and serves to separate pixels, with, for each pixel, one absorption piece 6, one lower electrode 10 and one lower piece 5 laid upon each other. A plurality of spraying heads 1 is disposed above the barriers 2 and below the higher layer 8.

The spraying heads 1 are SE-128 spraying heads of piezoelectric sprayers or thermal bubble spraying heads. A reflective wavelength of the CLC material 4 of 550 nm (green) is used first. For high reproducibility of sprayed droplets, a viscosity thereof of 1-15 cps is used. However, regular CLC material has a high viscosity and is not suitable for SE-128 spraying heads. Therefore, temperature is raised to decrease viscosity until reliable and reproducible spraying is achieved. The appropriate temperature is found experimentally. Experience shows that viscosity decreases with rising temperature and vice versa. As shown in FIG. 2, a temperature of 6020 C. results in a viscosity of 10 cps, which is suitable for spraying.

With an appropriate temperature assumed, spraying is performed, as shown in FIG. 3, where 1a denotes a spraying head. Pictures of FIG. 3 have been taken in intervals of 15 μs, showing that clear droplets are formed and demonstrating that by increasing temperature stable and reproducible spraying is achieved.

FIG. 4 shows a dot pattern generated by spraying, having dots with diameters of 120 μm and mutual distances of 300 μm in a horizontal direction and of 508 82 m in a vertical direction. After continuous spraying, a strip pattern is generated, as shown in FIG. 5, with strips having widths of 120 μm and mutual distances of 508 μm. FIGS. 4 and 5 show clearly that no satellite droplets are generated, so that stable and well-defined spraying on the lower pieces 5 on the lower substrate 3 is performed, without properties of the CLC material 4 and the spraying heads 1 not suiting each other.

CLC material for green color is sprayed on a substrate as dots or strips. Similarly, CLC material for other colors, like red and blue, is sprayed in any desired pattern, like a mosaic-like or triangular pattern. Used CLC material has a wide frequency range of reflectivity with a high birefringence difference or a narrow frequency range of reflectivity. In the present invention, either rflective or transmissive CLC material is used. The present invention ensures high efficiency, low manufacturing cost, high luminosity and contrast, low power consumption, memory capability, a wide viewing angle and no scintillation, while offering full-color display.

For implementing the production method of the present invention, a substrate and barriers are made, then CLC material for three colors, red, green and blue, is sprayed in cells divided by the barriers, as shown in FIG. 7a. Monochrome panels of 160×160×3 pixels and 7×7 cm² are created, as shown in FIGS. 7b and 7c.

Above embodiment allows to manufacture inexpensive and simple displays which consume little power, as compared to transparent liquid crystal panels, 1/50 or less. As compared to conventional STN or TFT displays, power consumption is lower due to memory capabilities, which allow for powerless display as long as images do not change, like in still display of e-book pages. Static display is maintained even upon failure of a power cord or battery. Thus the present invention is suited to outdoor and portable applications, like commercial billboards or portable devices.

Referring to FIG. 6, for use as a color filter of high efficiency, the present invention in another embodiment comprises: a plurality of barriers 12; a lower layer 13; cholesteric liquid crystal (CLC) material 14; a higher layer 15; a higher substrate 16; and a lower substrate 17. A plurality of spraying heads 11 is disposed above the barriers 12. Through the spraying heads 11, CLC material of red, green and blue colors is sprayed on the lower layer 13, between the barriers 12 thereon, which is laid on the lower substrate 17, made of glass or plastics. Similarly as described above, spraying patterns are dots, squares, triangles, strips or mosaic-like patterns.

It is well known that color filters are the most expensive components of full-color displays, while transparency thereof is low due to losses. Color filters have transparencies of only about 28%, with further losses in upper and lower polarizers reaching up to 50%, resulting in a total transparency of 7% of conventional LCDs. In contrast thereto, CLCDs generate polarized light, resulting in a total transparency of 26.8%, as shown in the following calculation:
100%*30%*94%*95%=26.8%

As above explanation shows, the present invention offers the following advantages:
1. By using a spraying method, no limits as to shapes and sizes are given and quick and inexpensive production is possible without employing expensive processes like semiconductor manufacturing processes with photo-resist techniques. By usingsoftwarecontrol, anydesiredspraying pattern is achievable.
2. High luminosity and full-color display are attained without the use of polarizers. A transparency is achieved that is superior to that of STN and TFT displays.

### BRIEF DESCRIPTION OF THE DRAWINGS

FIG. 1 is a schematic illustration of the present invention.

FIG. 2 is a plot of viscosity as dependent on temperature of CLC material.

FIG. 3 is a temporal series of photographs of sprayed CLC material droplets of the present invention.

FIG. 4 is a photograph of a dot pattern of sprayed CLC material of the present invention.

FIG. 5 is a photograph of a dot pattern of sprayed CLC material of the present invention.

FIG. 6 is a schematic illustration of the present invention in another embodiment.

FIGS. 7a-7c are photographs of display panels generated by the method of the present invention, FIG. 7a showing a full-color display panel and FIGS. 7b and 7c showing monochrome display panels.

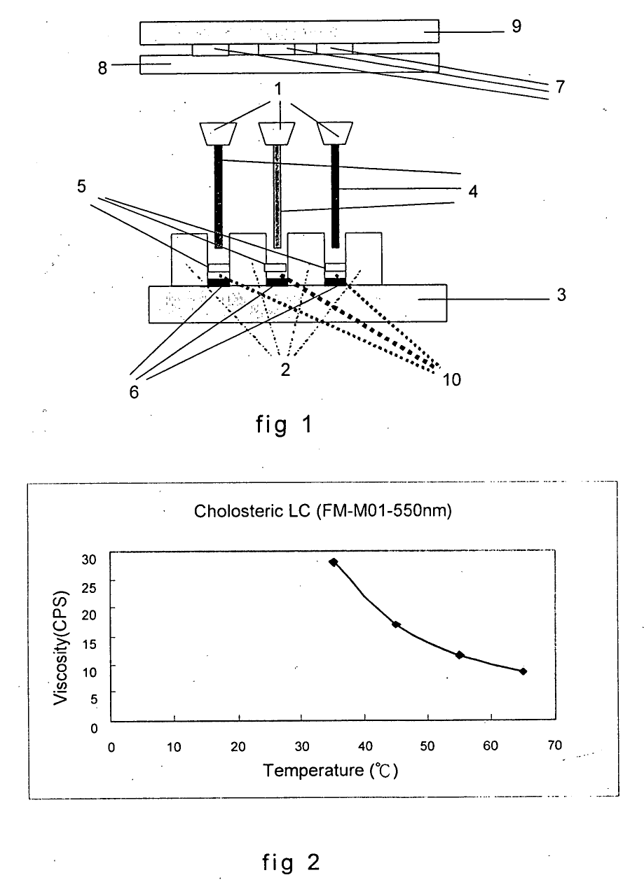

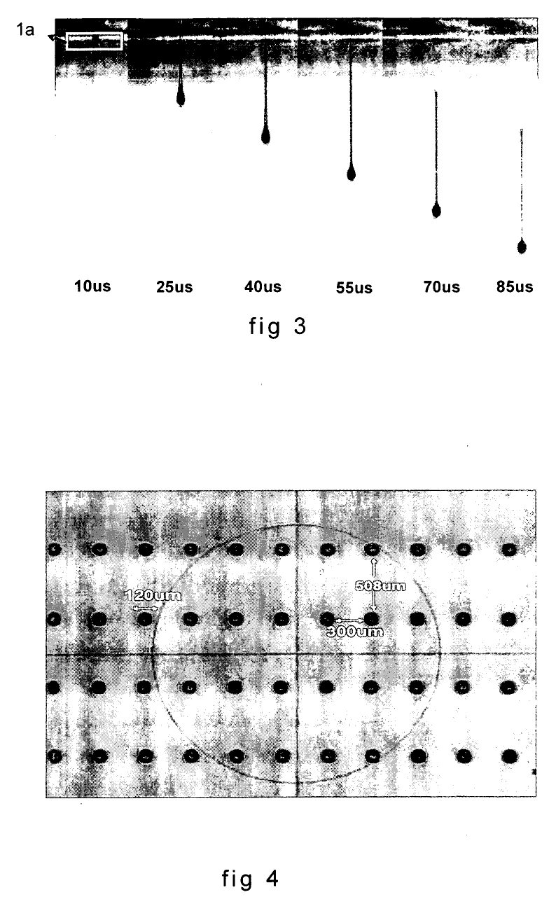

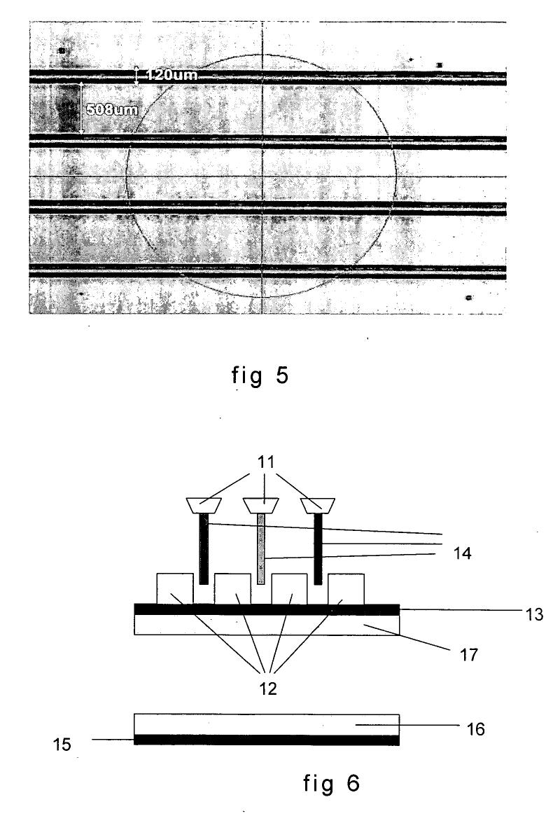

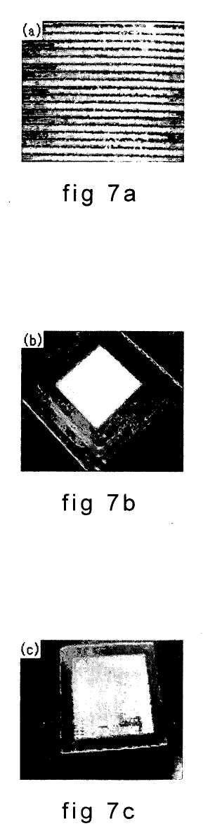

1. A dispersed cholesteric liquid crystal display, comprising: an upper substrate, an upper layer, a lower layer, divided by a plurality of barriers in a plurality of lower pieces placed in cells below which a plurality of absorption pieces are laid, a lower substrate, upper electrodes placed between said upper substrate and said upper layer, lower electrodes placed between said lower substrate and said lower layer, and cholesteric liquid. crystal (CLC) material placed on said plurality of lower pieces.

2. The dispersed cholesteric liquid crystal display according to claim 1, wherein said CLC material has narrow-frequency characteristics of either red or green or blue color, so that each of said cells corresponds to a red, green or blue pixel.

3. The dispersed cholesteric liquid crystal display according to claim 1, wherein said CLC material has broad-frequency or narrow-frequency characteristics of either red or green or blue color, so that each of said cells corresponds to a pixel of broad-frequency or narrow-frequency characteristics.

4. The dispersed cholesteric liquid crystal display according to claim 1, wherein said CLC material is reflective and has broad-frequency characteristics with a high birefringency difference.

5. The dispersed cholesteric liquid crystal display according to claim 1, wherein said CLC material is reflective and has narrow-frequency characteristics.

6. The dispersed cholesteric liquid crystal display according to claim 1, which is a reflective cholesteric liquid crystal display.

7. The dispersed cholesteric liquid crystal display according to claim 1, which is a transmissive or reflective cholesteric liquid crystal display.

8. A color filter for a dispersed cholesteric liquid crystal display, comprising: an upper substrate, an upper layer, a lower layer, divided by a plurality of barriers in a plurality of cells into which cholesteric liquid crystal (CLC) material is sprayed, and a lower substrate.

9. The dispersed cholesteric liquid crystal color filter according to claim 8, wherein said CLC material has narrow-frequency characteristics of either red or green or blue color, so that each of said cells corresponds to a red, green or blue pixel and wherein said cells are of any shape, like triangular, square, elongated or mosaic-like shape.

10. A method for manufacturing a dispersed cholesteric liquid crystal display, comprising the steps of:
(1) placing barriers on a substrate;
(2) laying absorption pieces into cells divided by said barriers; and
(3) spraying cholesteric liquid crystal (CLC) material with broad-frequency or narrow-frequency characteristics into said cells, so that full-color or monochrome display is achieved.

11. The method for manufacturing a dispersed cholesteric liquid crystal display according to claim 10, wherein CLC material with red, green or blue color characteristics is respectively sprayed into said cells and wherein said step of spraying CLC material into said cells comprises
(a) raising temperature of CLC material to be sprayed, so as to lower viscosoty thereof; and
(b) spraying CLC material of suitable viscosity into said cells for achieving full-color display.

12. The method for manufacturing a dispersed cholesteric liquid crystal display according to claim 10, wherein CLC material with narrow-frequency characteristics is sprayed into said cells and wherein said step of spraying CLC material into said cells comprises
(a) raising temperature of CLC material to be sprayed, so as to lower viscosoty thereof; and
(b) spraying CLC material of suitable viscosity into said cells for achieving monochrome display.

13. The method for manufacturing a dispersed cholesteric liquid crystal display according to claim 10, wherein spraying of CLC material is performed using thermal bubble technology.

14. The method for manufacturing a dispersed cholesteric liquid crystal display according to claim 10, wherein spraying of CLC material is performed using continuous spraying technology.

15. The method for manufacturing a dispersed cholesteric liquid crystal display according to claim 10, wherein spraying of CLC material is performed using piezoelectric technology.

16. A method for manufacturing a dispersed cholesteric liquid crystal display, comprising the steps of:
(1) placing barriers on a substrate; and
(2) spraying cholesteric liquid crystal (CLC) material with broad-frequency or narrow-frequency characteristics into said cells, so that full-color or monochrome display is achieved.

17. The method for manufacturing a dispersed cholesteric liquid crystal display according to claim 16, wherein CLC material with red, green or blue color characteristics is respectively sprayed into said cells and wherein said step of spraying CLC material into said cells comprises
(a) raising temperature of CLC material to be sprayed, so as to lower viscosoty thereof; and
(b) spraying CLC material of suitable viscosity into said cells for achieving full-color display.

18. The method for manufacturing a dispersed cholesteric liquid crystal display according to claim 16, wherein spraying of CLC material is performed using thermal bubble technology.

19. The method for manufacturing a dispersed cholesteric liquid crystal display according to claim 16, wherein spraying of CLC material is performed using continuous spraying technology.

20. The method for manufacturing a dispersed cholesteric liquid crystal display according to claim 16, wherein spraying of CLC material is performed using piezoelectric technology.
